(19) United States
(12) Patent Application Publication
(10) Pub. No.: US 2008/0026615 A1
(43) Pub. Date: Jan. 31, 2008

(54) Self terminating spigot

(76) Inventor: John G. Low, Bradford (CA)

Correspondence Address: GEORGE A. ROLSTON, 45 SHEPPARD AVE EAST, SUITE 900, TORONTO, ON, M2N5W9, CA

(21) Appl. No.: 11/812,122

(22) Filed: Jun. 15, 2007

Related U.S. Application Data
(60) Provisional application No. 60/814,087, filed on Jun. 16, 2006.

(51) Int. Cl. H01R 13/44

(52) U.S. Cl. 439/137

(57) ABSTRACT

A self terminating spigot for a digital cable system and having a circuit providing a short circuit connection, and a resistance in the circuit, which , when the spigot is in use, is inactive, and when the spigot is not in use, the resistance will connect in circuit thereby terminating the signal at the spigot.

### FIELD OF THE INVENTION

The invention relates to a spigot outlet for delivering digital cable signals, and in particular to a spigot for a cable system which is self-terminating, when not connected to a piece of equipment and is not being used. This application is based on U.S. Provisional 60/814,087. Filed Jun. 16, 2006

### BACKGROUND OF THE INVENTION

In the delivery of digital signals to various delivery points, it is common to use a terminal called a spigot. This is commonly used for delivering television and/or internet signal services in buildings, but may also be used for delivering other forms of signals in other locations. Typically the signals are delivered along a coaxial cable such as is well known in the art. Typically the spigot consists of a cylindrical body threaded at both ends, and mounted in for example a wall or some other panel or support. The spigot may also be simply the end of a cable or extension, in some cases. One end of the cylindrical body is connected to the coaxial feed cable. The other end of the cylindrical body has a connection consisting of an exterior threaded sleeve. This sleeve can be connected a coaxial delivery cable connecting to a piece of equipment such as a television set or computer. The delivery cable has a threaded cap which mates with the threaded sleeve of the spigot.

The connection of equipment of various kinds such as television sets, computers and the like to such spigots is well known.

When delivering digital signals through such spigots, it is found that, when the spigot is not connected to a piece of equipment, the spigot can in fact act as a source of noise signals, which are transmitted back up the coaxial cable.

Typically these noise signals will originate from the digital signals in the coaxial cable itself, but they may also possibly be coming from other sources. Such noise signals impair the quality of the digital feed signals within the system.

In order to overcome this problems, it is common for signal suppliers such as cable television or internet signal supplier to cap the ends of the spigots when they are not in use. However, it is clearly impossible, cap all of the spigots which are not in use in any particular location. For example a household may have spigot outlets for each room. The occupants may not always use all of the spigots. It is impractical for the signal supplier or the cable company to come into a private home and insist on capping spigots not in use.

### BRIEF SUMMARY OF THE INVENTION

The invention therefore provides an electrical outlet or spigot which is self-terminating. The spigot will incorporate a form of short circuit and a resistance. When the spigot is not in use, the resistance will have the effect of capping the spigot and terminating the signal at that point thus preventing the unwanted pick up of noise signals.

Preferably, the spigot will incorporate a sliding contact, and some form of resilient device or spring. When a piece of equipment, such as television or internet connection cable is connected to the spigot, the sliding contact will be disabled. However, when the equipment is disconnected, and the spigot is not in use the resilient device will cause the sliding contact to reconnect putting the resistance in circuit and thereby terminating the signals at the spigot.

Preferably the resistance is incorporated in the typical spigot body, together with a spring and sliding contact. In this way there is no interference with the connection of conventional coaxial cable devices.

Preferably the resistance is in the form of an annular washer-like body, with contact surfaces at both sides.

In another form the resistance can be a typical resistor body having contacts at each end.

Preferably there is a non-conductive plug slidably received in the spigot body and sliding inwardly, when the co-axial cable is connected.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a side elevation of a spigot;

FIG. 2 is a section along 2-2 of FIG. 1;

FIG. 3 is a side elevation of a cable connector;

FIG. 4 is an exploded view of a self-terminating spigot illustrating the invention;

FIG. 5 is a chart showing the hatching codes for FIG. 4;

FIG. 6 is an enlarged cross-section of the spigot of FIG. 4, assembled;

FIG. 7 is a section along the line 7-7 of FIG. 6;

FIG. 8 is a section along the line 8-8 of FIG. 6;

FIG. 9 is a section along the line 9-9 of FIG. 6;

FIG. 10 is a view of an alternate embodiment, assembled;

FIG. 11 is an exploded view of FIG. 10 embodiment;

FIG. 12 is an enlarged side elevation of the resistor of FIG. 10;

### DESCRIPTION OF A SPECIFIC EMBODIMENT

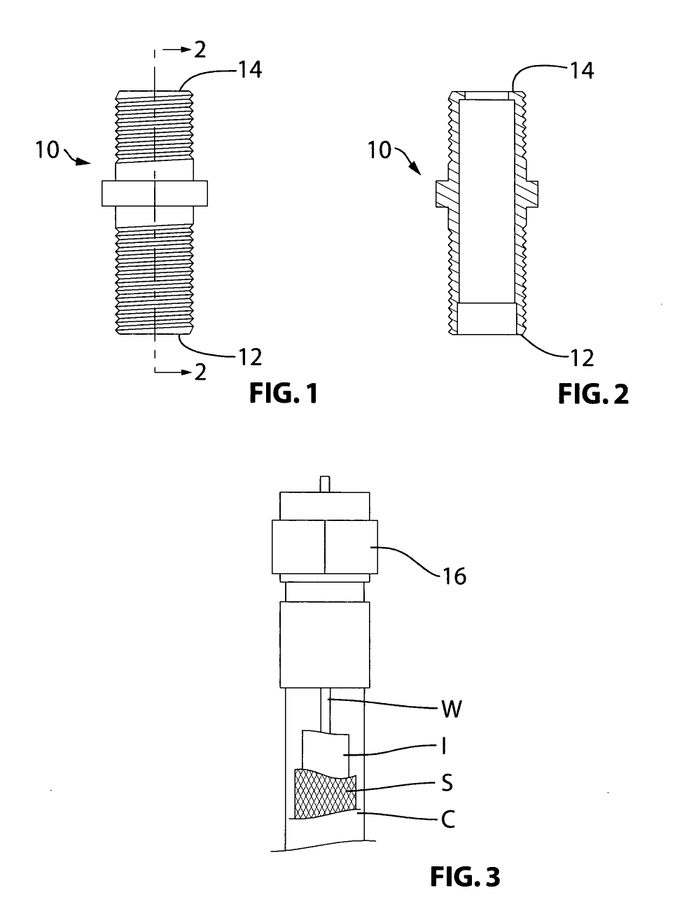

Referring now to FIG. 1 it will be seen that the invention is incorporated in a spigot body (10). The spigot body is an essentially cylindrical metal conductive body, having a hollow interior, and with exterior threads at both ends. Typically it will have a hexagon or other drive surface between the two ends.

The spigot body has an internal feed cable end (12) and an external outlet end (14). The internal feed end is typically connected to a connector (16) of a cable supply system or other form of signal supply located within the building. The spigot itself is typically mounted in a wall mounting plate. However it may be mounted as part of a separate piece of equipment, such as a cable splitter, or a router, or extension cable, or other form of equipment used in the distribution of signals.

As is well known, a coaxial cable C for supplying the signal has a central conductor wire W, and flexible co-axial conductor sleeve S, separated by a continuous insulation sheath I running between them. Typically, such a coaxial cable will have a connector (16) attached to the end in well known manner, the connector (16) having an internally threaded sleeve which can be connected to the external threads on outlet end (14) on the spigot. All this is well known in the art.

In like manner the cable connecting the piece of equipment to the spigot outlet to receive the signal, consists of a cable with a similar connected end, which has threads and can be threaded onto external threads of a connection point; for example a television set, computer (not shown), or the like.

In order to “terminate” the outlet end (14) of the spigot body (10), when it is not connected to a piece of equipment, the spigot is provided with a circuit incorporating an internal resistive connection illustrated in FIGS. 2, 3, 4, 8 and 9.

The internal resistive circuit comprises a resistor coil (20), typically having connectors (22)-(24) at either end.

The internal feed end (12) of the spigot body has a conductive socket (26), and a non-conductive insulating sleeve (28). The centre part of the cable will be received in the socket (26). The coaxial sheath is connected via a typical cable connector (16), and will couple directly to the outside of the spigot body.

The delivery outlet end (14) of the spigot body is provided with a similar central conductive socket (30), and a generally similar insulating sleeve (32). The socket (30) and its insulating sleeve (32) are slidable within the spigot body (10), against the pressure of spring (34).

Resistor (20) is received in the insulating sleeve (32). Preferably the two are moulded together, but clearly the insulating sleeve (32) could be formed with a recess and the resistor could be placed in the recess during assembly. A washer (36) of conductive material fits around the outer end of the insulating sleeve (32).

The resistor has conductive ends or tips (22) and (24) and forms a circuit. The one conductive tip (24), is received in a recess (38) in the socket (30).

The other conductive tip (22) extends from the insulating sleeve (32), and is arranged to come into contact with the conductive washer (36), when the spigot is not in use. This will close the circuit causing signals to short out to body (12).

When the spigot is in use, the attachment of the connecting cable connecting the spigot to a piece of equipment, such as a television, or computer will cause the insulating sleeve (32) and the socket (30) to slide inwardly against the pressure of the spring (34). This will disconnect the resistor (20), from washer (36) and body (12).

The circuit is thus disabled.

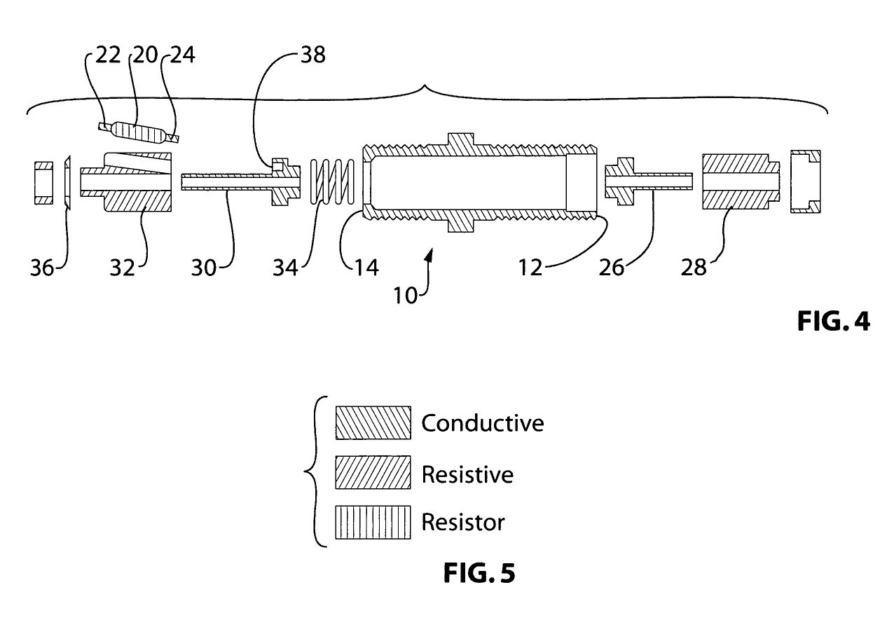

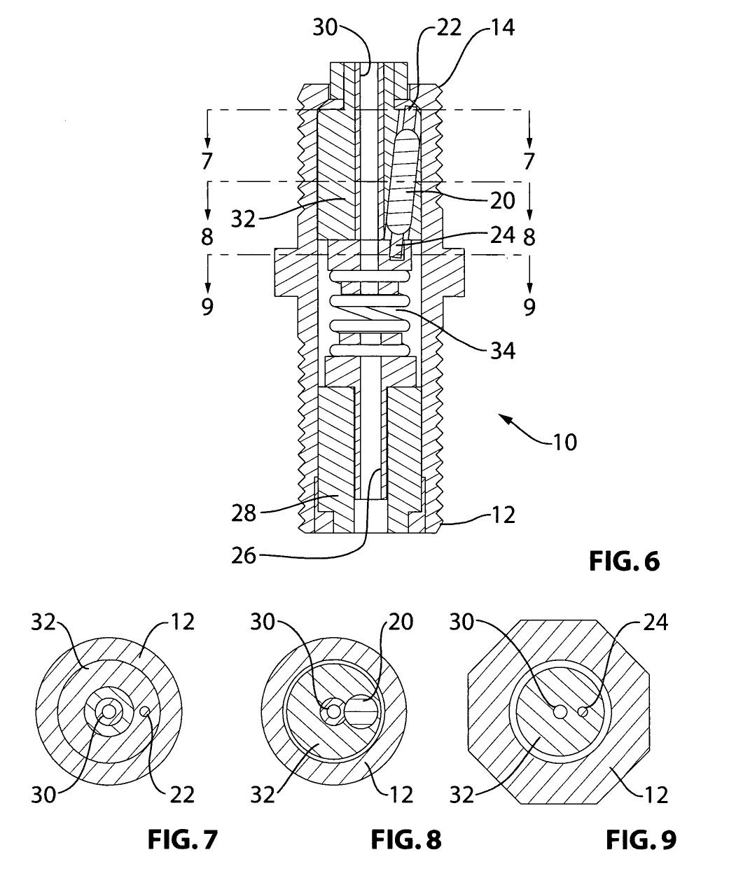

Digital signals will then be delivered directly to or from the connecting coaxial cable and thus to or from the piece of equipment. Such signals, in the FIG. 4 embodiment will pass from socket (26), through spring (34) to socket (30).

When the coaxial cable connector is removed, the spring (34) will cause the insulating sleeve (32) and the, socket (30) to move outwardly (left in FIG. 4), and this will bring the tip (22) of the resistor (20) and washer (36) into contact with sleeve (12). This will then complete the circuit between the centre conductor of the feed coaxial cable and the outer sheathing of the cable, through the body (10).

The resistor (20) is calculated so as to provide a resistive load equal to the current being supplied. Typically this resistive load will be 75 Ohms, in case of the typical television cable, or internet cable supply system.

In other supply systems, where signals of other strengths are being supplied, then the resistor will be calculated accordingly.

Thus when the spigot is not connected to a piece of equipment and is therefore not in use, the spigot is essentially dead and is terminated, by the connection of the resistor between the centre conductor and sheathing.

When the spigot is in use and the piece of equipment is connected by a typical delivery cable, then the resistor will be disconnected from the circuit and digital signals will flow through the spigot to the piece of equipment in the normal way.

This system will therefore provide a termination for all unused spigots and will avoid the necessity for signal supply companies such as cable companies from attempting to cap all unused spigots.

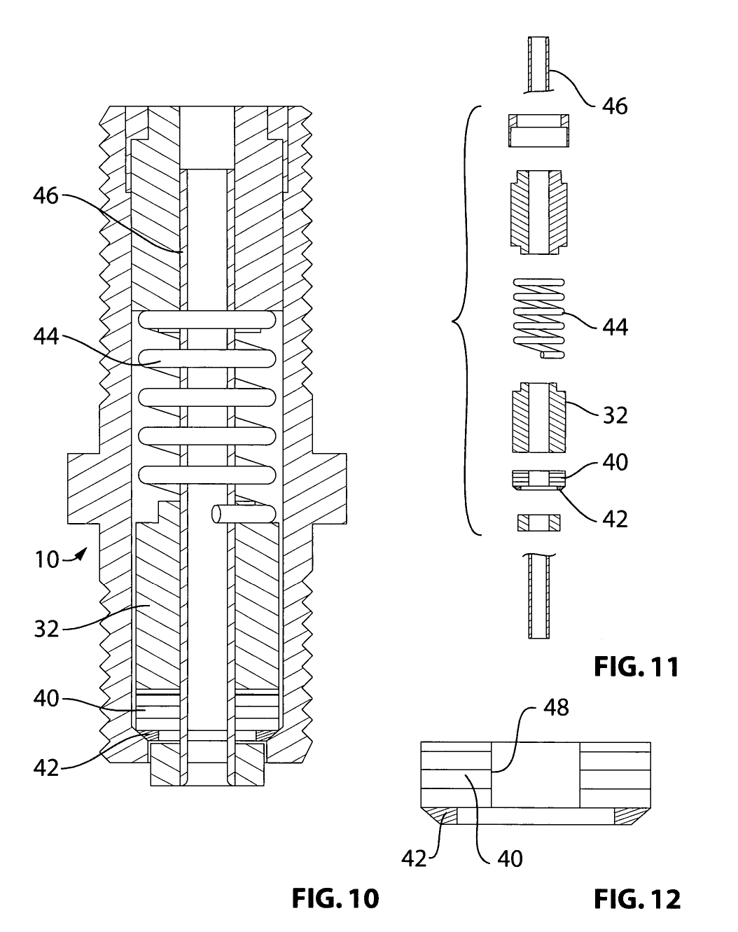

Another embodiment is shown in FIGS. 10, 11, and 12.

In this case the body (10) remains uncharged. The resistor (22) is replaced by a resistor (40). Resistor (40) is in the shape of an annular ring. It has a first planar surface, and a second planar surface opposite there to.

A conductor ring (42) is located on the second planar surface of the resistor (40).

A spring (44) urges non-conductive sleeve (32) and the resistor (40) outwardly.

Conductive tube (46) connects from one end to the other.

The internal annular surface (48) of resistor is also conductive and slides on tube (46). In this way the resistor acts as a moveable contact.

The circuit is enabled, when the ring (42) contacts body (10).

The circuit is disabled when the ring (42) is out of contact with body (10).

The resistor could be located elsewhere, and could be fixed. The system would then require moveable contacts.

The present system with the resistor itself providing the moveable contact is believed to be both effective, and economical.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A self terminating spigot for a digital cable system and comprising;
a circuit providing a short circuit connection;
a resistance in the circuit, which , when the spigot is in use, is inactive, and when the spigot is not in use, the resistance will connect in circuit thereby terminating the signal at the spigot.

2. A self terminating spigot for a digital cable system as claimed in claim 1 which incorporates a sliding contact for connecting the circuit, and a resilient device whereby when a cable is connected to the spigot, the sliding contact will be disabled, and, when the cable is disconnected, the resilient device will cause the sliding contact to reconnect the circuit thereby terminating the signals at the spigot.

3. A self terminating spigot for a digital cable system as claimed in claim 2 wherein the resistance is incorporated in the spigot body, and including a spring and sliding contact.

4. A self terminating spigot for a digital cable system as claimed in claim 2 wherein the resistance is in the form of an annular washer-like body, having two contact surfaces.

5. A self terminating spigot for a digital cable system as claimed in claim 2 wherein the resistance comprises a resistor body having contacts at each end.

6. A self terminating spigot for a digital cable system as claimed in claim 2 and including a non-conductive plug slidably received in the spigot and sliding inwardly, when the spigot is in use.

7. A self terminating spigot for a digital cable system as claimed in claim 2 wherein the spigot has a body defining two ends, exterior threads on both ends, a hollow interior, and a cable connection extending through said hollow interior, and insulation separating said cable connection from said body,

8. A self terminating spigot for a digital cable system as claimed in claim 7 including a resistor body of generally annular shape, sliding on said cable connection.

9. A self terminating spigot for a digital cable system as claimed in claim 8 wherein said resistor defines a first contact surface in contact with said cable connection, and a second contact surface oriented to contact said spigot body.

10. A self terminating spigot for a digital cable system as claimed in claim 9 including a spring in said hollow interior of said spigot body urging said resistance into contact with said spigot body.

11. A self terminating spigot for a digital cable system as claimed in claim 10 including a non-conductive insulation body engaging said resistor, and said spring engaging said insulation body.

12. A self terminating spigot for a digital cable system as claimed in claim 2 wherein the spigot has a body defining two ends, exterior threads on both ends, a hollow interior, and a cable connection extending through said hollow interior, and insulation separating said cable connection from said body;

13. A self terminating spigot for a digital co-axial cable system in which the co-axial cable has a centre wire conductor, and an outer conductive sheath, and comprising;
a spigot body of hollow tubular shape having threads at at least one end;
a central conductor for connecting with a centre wire of the co-axial cable, extending through the spigot body, the body acting as a conductor for the outer wire sheath of the co-axial cable;
a resistor body of generally annular shape, sliding on said central conductor;
a first contact surface on said resistor in sliding contact with said central conductor;
a second contact surface on said resistor oriented to contact said spigot body;
a spring in said hollow interior of said spigot body urging said resistor into contact with said spigot body;
a non-conductive insulation body engaging said resistor, and said spring engaging said insulation body.

14. A self terminating spigot for a digital cable system as claimed in claim 13 wherein the resistor defines an annular interior conductive surface in sliding contact with said central conductor.

15. A self terminating spigot for a digital cable system as claimed in claim 14 wherein said resistor defines a first planar surface in contact with said non-conductive body, and a second planar surface, on a side opposite to said first planar surface, and a contact device on said second planar surface.
